(19) United States
(12) Patent Application Publication
(10) Pub. No.: US 2026/0301725 A1
(43) Pub. Date: Oct. 1, 2026

(54) ELECTRONIC MUSICAL INSTRUMENT

(71) Applicant: YAMAHA CORPORATION, Hamamatsu-shi (JP)

(72) Inventors: Yuichiro SUENAGA, Hamamatsu-shi (JP); Banri ABE, Hamamatsu-shi (JP)

(21) Appl. No.: 19/578,044

(22) Filed: Mar. 25, 2026

(30) Foreign Application Priority Data
Mar. 27, 2025 (JP) 2025-054491

(51) Int. Cl. G10H 3/14; G10D 13/10

(52) U.S. Cl. CPC G10H 3/146; G10D 13/26; G10H 2220/461

(57) ABSTRACT

An electronic musical instrument is provided, the electronic musical instrument comprises: a first sensor that detects a change in a sensing target that varies with playing, and outputs a first sensor signal corresponding to a detected change; a second sensor that detects the change in the sensing target, and outputs a second sensor signal corresponding to the detected change, the second sensor being positioned differently from the first sensor; and a sound source that generates first sound data based on the first sensor signal and second sound data based on the second sensor signal in response to the playing, and transmits the first sound data and the second sound data simultaneously.

### CROSS-REFERENCE TO RELATED APPLICATIONS

This application claims the benefit of priority to Japanese Patent Application No. 2025-054491, filed on Mar. 27, 2025, the entire contents of which are incorporated herein by reference.

### FIELD

The present disclosure relates to an electronic musical instrument that outputs a sound in response to vibration imparted to a drumhead.

### BACKGROUND

An electronic drum or a dampened acoustic drum outputs a sound from a sound source based on vibration due to an impact on a head or a rim. Therefore, a sensor for detecting vibration imparted to the head or the rim is installed in the electronic drum or the dampened acoustic drum.

The acoustic drum outputs sounds of different tones depending on the hitting position. The electronic drum is also required to output a natural tone sound corresponding to the hitting position. For example, Japanese laid-open patent publication No. 2018-036641 discloses an electronic percussion instrument that includes a plurality of sensors, specifies a hitting position based on a detection signal from the plurality of sensors, and outputs a sound based on the specified hitting position.

### SUMMARY

An electronic musical instrument according to an embodiment of the present invention includes a first sensor that detects a change in a sensing target that varies with playing, and outputs a first sensor signal corresponding to a detected change; a second sensor that detects the change in the sensing target, and outputs a second sensor signal corresponding to the detected change, the second sensor being positioned differently from the first sensor; and a sound source that generates first sound data based on the first sensor signal and second sound data based on the second sensor signal in response to the playing, and transmits the first sound data and the second sound data simultaneously.

### BRIEF DESCRITION OF DRAWINGS

FIG. 1 is a diagram showing an electronic drum according to an embodiment.

FIG. 2 is an exploded perspective view of a snare drum in an embodiment.

FIG. 3 is a schematic view showing a configuration of a frame according to an embodiment.

FIG. 4 is a cross-sectional view showing a configuration of a frame along a line A-B in FIG. 3.

FIG. 5 is a block diagram showing a configuration of a sound source of a control device according to an embodiment.

FIG. 6 is a block diagram showing a configuration of a sound data generation unit according to an embodiment.

FIG. 7 is a block diagram showing a configuration of a sound data generation unit according to another embodiment.

### DESCRIPTION OF EMBODIMENTS

In an electronic percussion instrument disclosed in Japanese laid-open patent publication No. 2018-036641, a complicated process is performed to specify a hitting position based on a detected vibration and to control a sound based on the specified hitting position in order to output a sound corresponding to the hit. As a result, a delay is likely to occur from playing to the output of a sound. In addition, depending on the detected vibration state, there is a possibility that an incorrect identification is made at the time of specifying the hitting position, and there is a possibility that a performance sound cannot be accurately generated for the playing.

According to the present disclosure, in an electronic musical instrument, it is possible to further reduce a delay caused by sound control according to the playing, and to accurately generate a performance sound for the playing.

Hereinafter, embodiments of the present disclosure will be described in detail with reference to drawings. The following embodiments are examples, and the present disclosure should not be construed as being limited to these embodiments. In the drawings referred to in the present embodiments, the same portions or portions having similar functions are denoted by identical signs or similar signs (signs each formed simply by adding A, B, etc. to the end of a number), and a repetitive description thereof may be omitted. The drawings may be presented schematically to clarify explanations, with dimensional ratios differing from actual ratios or certain components omitted from the drawing.

### First Embodiment

### Configuration of Electronic Music Instrument

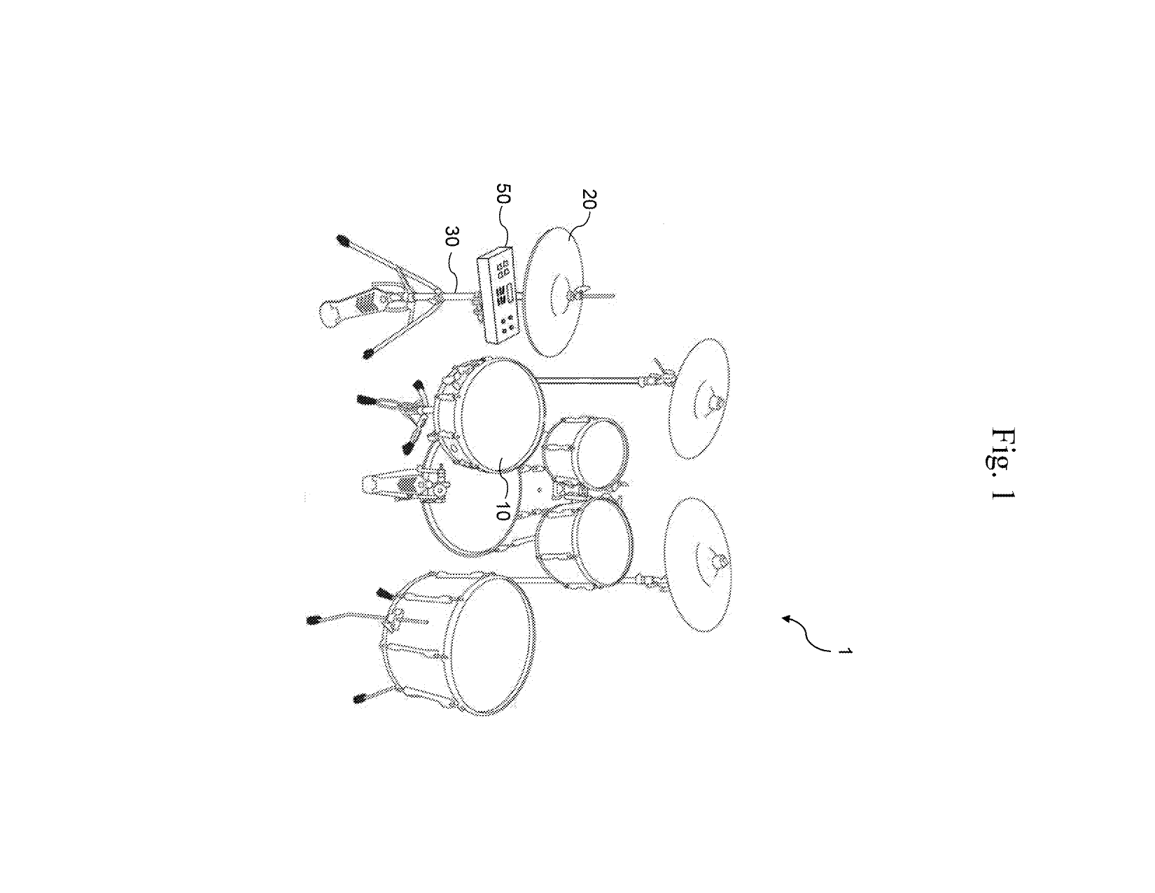

FIG. 1 is a diagram showing an electronic drum set according to an embodiment of the present disclosure. An electronic drum set 1 according to the present embodiment includes a bass drum, a snare drum 10, a tom drum, a floor tom drum, hi-hat cymbals 20, a crush cymbal, a ride cymbal, and a control device 50. In the present embodiment, for example, the control device 50 is installed on a stand 30 of the hi-hat cymbals 20.

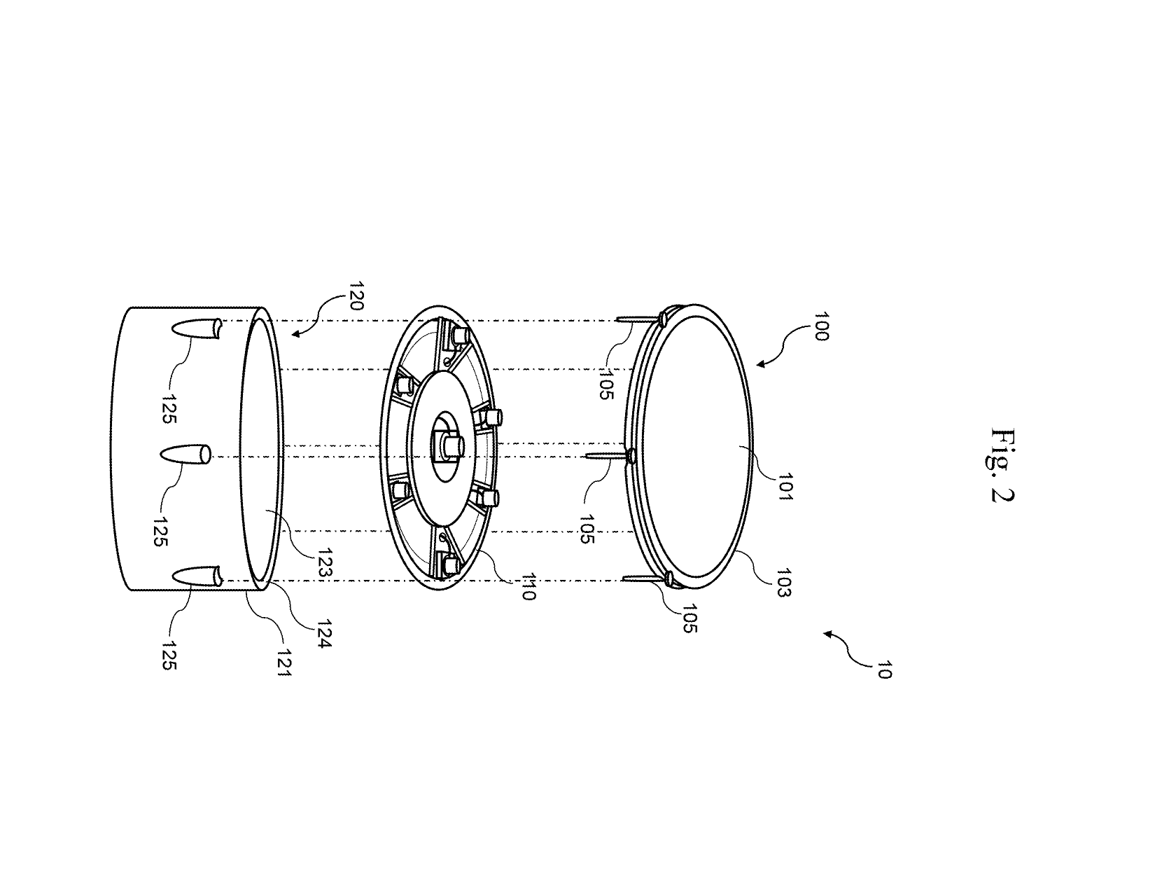

FIG. 2 is an exploded perspective view of the snare drum 10 according to the present embodiment. The snare drum 10 includes a head 100, a frame 110, and a shell 120. In the present embodiment, when a user plays the electronic drum set 1, the side on which a surface that is struck using a stick or the like, that is, the head 100, is arranged is referred to as an upper side of the electronic drum set 1, and the side opposite to the side on which the surface (the head 100) that is struck is arranged is referred to as a lower side of the electronic drum set 1. The head 100, the frame 110, and the shell 120 are arranged in this order from the upper side to the lower side of the electronic drum set 1.

The head 100 includes a drumhead 101 and a rim 103. The drumhead 101 is formed of a mesh-like material made of synthetic fibers and a film-like material made of resin. In this case, the drumhead 101 has a circular shape. The rim 103 supports the drumhead 101 while applying tension. Specifically, the rim 103 applies a fastening force of a fastening component 105 to the drumhead 101 to stretch the drumhead 101. Although not shown in the drawing, a through hole into which the fastening component 105 is inserted is provided to the rim 103.

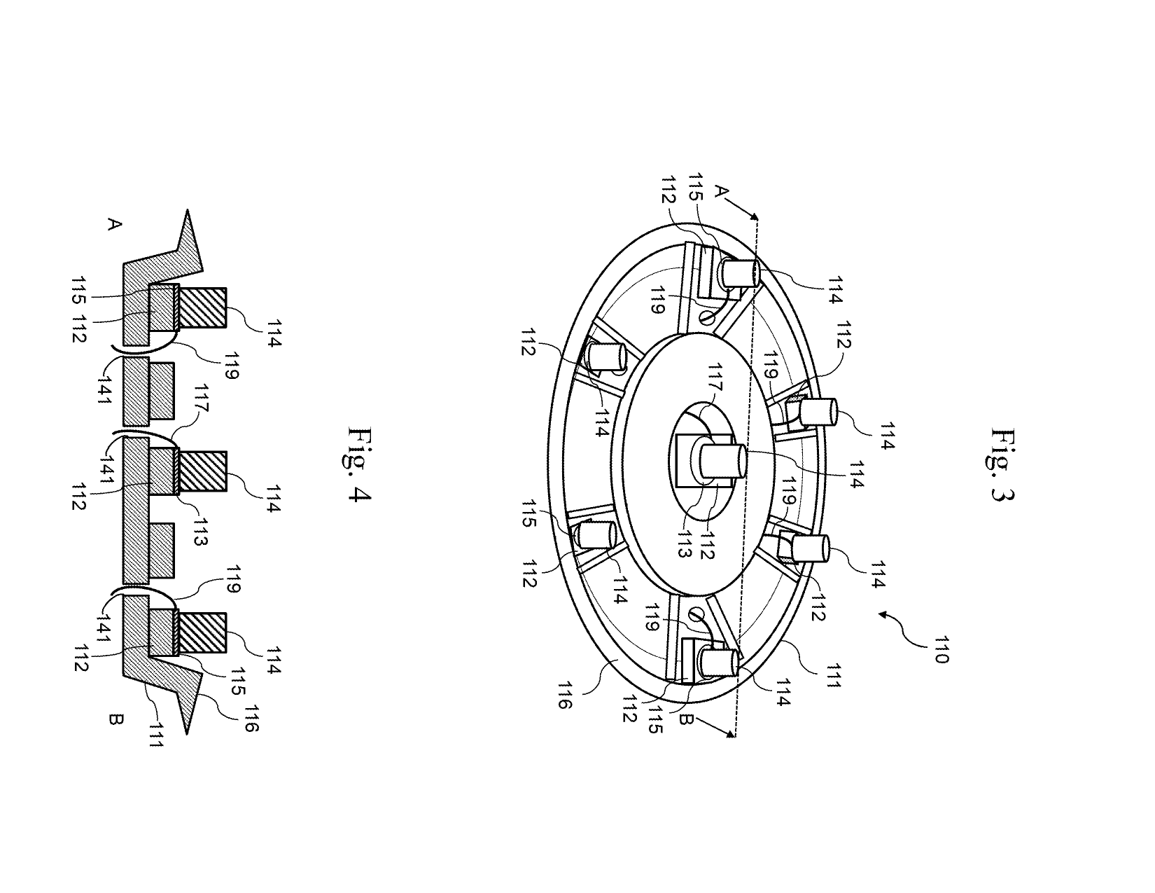

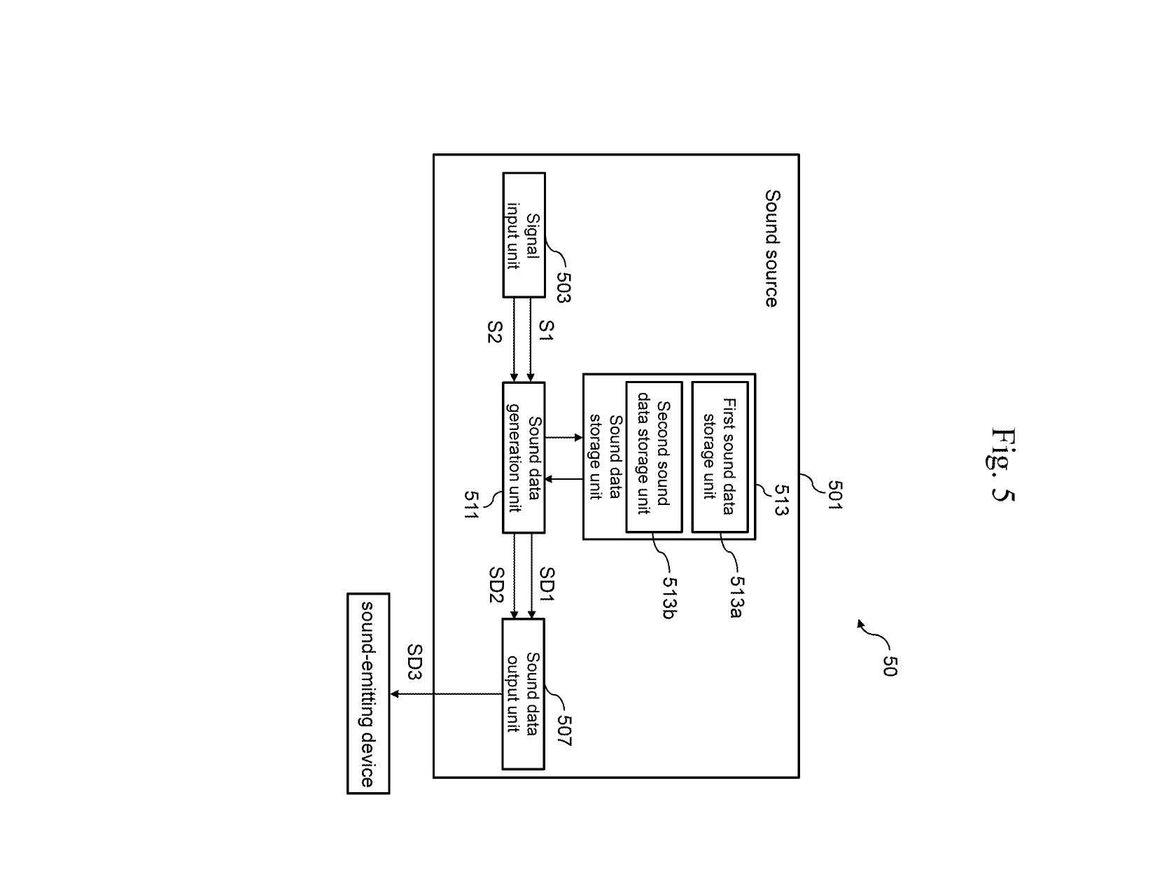

The frame 110 includes one or more sensors and a substrate (not shown in the drawing) to which the sensor is electrically connected. FIG. 3 is a schematic view showing a configuration of the frame 110, and FIG. 4 is a cross-sectional view showing the configuration of the frame 110 along a line A-B in FIG. 3. The frame 110 includes a frame body 111, a first sensor 113, a second sensor 115, a first wiring 117, and a second wiring 119.

The frame body 111 is composed of an insulating material and is made of, for example, resin. The frame body 111 has a circular shape and has protrusions 112 on a center of the frame body 111 and at a plurality of positions of an outer edge 116 side separated from the center, respectively. The first sensor 113 is arranged and fixed on the protrusion 112 provided on the center of the frame body 111. A plurality of second sensors 115 is arranged and fixed on a plurality of protrusions 112 positioned on the outer edge 116. In the present embodiment, there is one first sensor 113 and six second sensors 115 is. However, the number of the second sensors 115 is not limited to six, and may be three or more. The second sensors 115 are arranged at equal intervals on the circumference of a circle centered on the first sensor 113 in a plan view. In addition, the first sensor 113 and the second sensor 115 are arranged at different positions in the radial direction of the circle around the first sensor 113 on the frame 110, but the number is not limited to two. For example, a third sensor may be provided between the first sensor 113 and the second sensor 115 to generate a sound of a tone corresponding to the third sensor simultaneously with the sounds corresponding to the first sensor 113 and the second sensor 115.

The first sensor 113 and the second sensors 115 detect a change in the sensing target in which the magnitude of the output changes continuously or in multiple stages depending on the playing of the snare drum 10. In the present embodiment, the sensing target is the drumhead 101 of the snare drum 10, and the change in the sensing target is the vibration imparted to the drumhead 101 by the playing. The first sensor 113 and the second sensors 115 are, for example, but not limited to, an electro-magnetic sensor, a piezoelectric sensor, a pressure sensor, and the like.

An elastic member 114 is arranged on the upper surfaces of the first sensor 113 and each of the second sensors 115. An upper end portion of the elastic member 114 protrudes above the upper surface of the frame body 111, i.e., toward the head 100. When the frame body 111 and the head 100 are attached to a shell 120 described below, the end portion of the elastic member 114 contacts the drumhead 101 of the head 100, respectively. The first sensor 113 and the second sensors 115 detect vibration imparted to the drumhead 101 via the elastic member 114.

The first sensor 113 outputs a first sensor signal S1 corresponding to the detected vibration, and the plurality of second sensors 115 output a second sensor signal S2 corresponding to the detected vibration, respectively. The first sensor signal S1 output from the first sensor 113 is supplied to the control device 50 via the first wiring 117. The second sensor signals S2 output from the plurality of second sensors 115 are respectively supplied to the control device 50 via the second wirings 119. The frame body 111 is provided with openings 141 through which the first wiring 117 and the second wiring 119 pass. Further, in the present embodiment, the first sensor signal S1 and the second sensor signal S2 are supplied to the control device 50 via wirings, that is, by wired communication, but may be supplied to the control device 50 by wireless communication.

The first sensor signal S1 has an output intensity corresponding to the vibration detected by the first sensor 113. The second sensor signal S2 has an output intensity corresponding to the vibration detected by the second sensor 115. In this case, the output intensity is the magnitude of the amplitude of the sensor signal. In the present embodiment, the output intensity of the second sensor signal S2 is an output intensity based on the sum of the respective second sensor signals S2 output from the plurality of second sensors 115, and may be, for example, the sum of the output intensities of the respective second sensor signals S2 output from the plurality of second sensors 115, or may be the averages thereof. Alternatively, the output intensity may be obtained by other calculation methods.

In other words, the difference between the detection sensitivity (a first detection sensitivity) with respect to the vibration at the central portion (a first area) of the drumhead 101 of the head 100 and the detection sensitivity (a second detection sensitivity) with respect to the vibration at the outer edge (a second area) of the drumhead 101, of the first sensor 113, is larger than the difference between the first detection sensitivity and the second detection sensitivity of the second sensor 115. That is, there is a difference between a sensitivity distribution of the first sensor 113 and a sensitivity distribution of the second sensor 115. Specifically, as the hitting position on the drumhead 101 gets closer to the center of the drumhead 101, the output intensity of the first sensor signal S1 output from the first sensor 113 increases, and as the hitting position gets farther from the center of the drumhead 101, the output intensity of the first sensor signal S1 decreases. On the other hand, the output intensity of the second sensor signals S2 output from the second sensors 115 is constant regardless of the hitting position on the drumhead 101.

Returning to FIG. 2, the snare drum 10 will be described. The shell 120 includes a cylindrical case 121, an opening 123, and a sealed section 125. The case 121 has the opening 123 on the upper side. The outer edge 116 of the frame body 111 of the frame 110 is arranged at an edge 124 of the opening 123. The fastening component 105 inserted into the through hole of the rim 103 is screwed into the sealed section 125. When the fastening component 105 is screwed into the sealed section 125, the head 100 and the frame 110 are fixed to the shell 120.

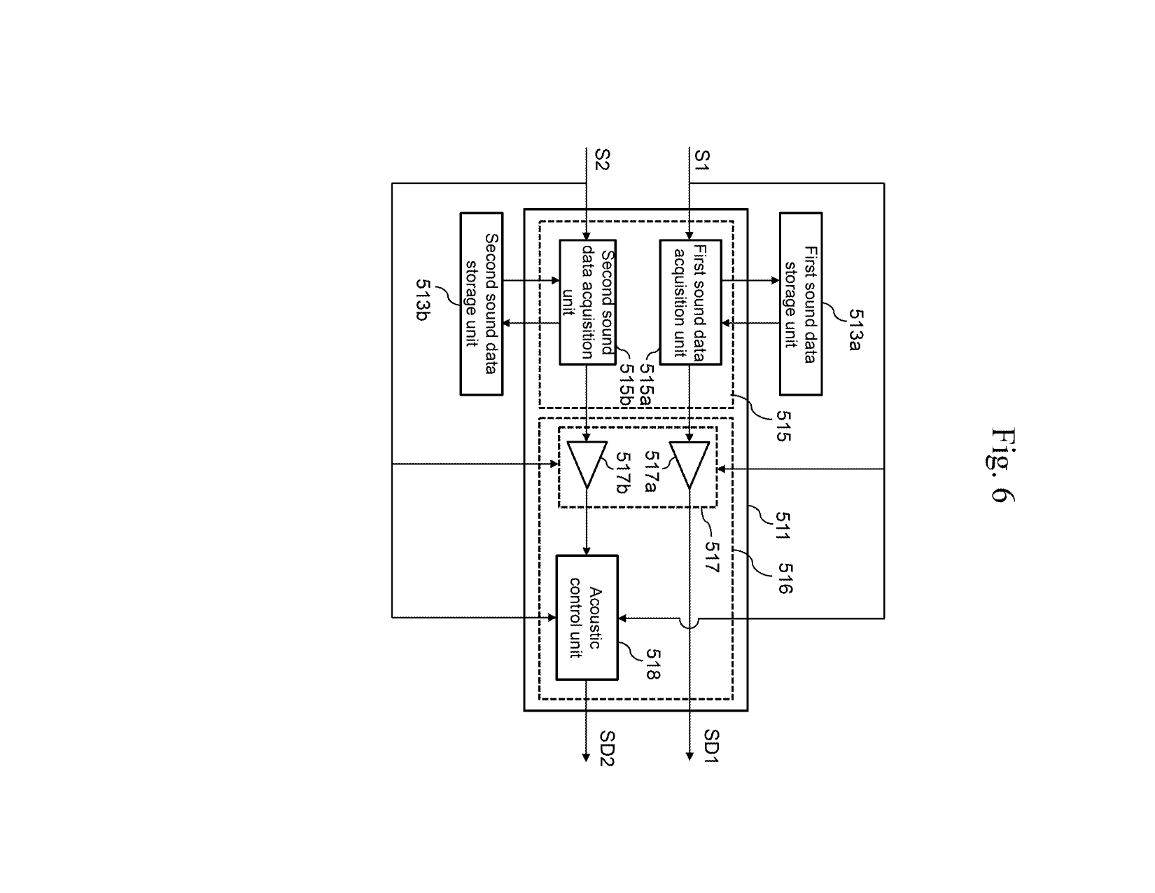

As described above, the first sensor signal S1 output from the first sensor 113 provided in the frame 110 and the second sensor signals S2 output from the second sensors 115 are supplied to the control device 50. The control device 50 includes an arithmetic processing circuit such as a CPU, storage devices such as RAM and ROM, and a sound source 501. Although not shown, the control device 50 executes a control program stored in a storage unit via the CPU to realize various functions. The storage unit is a storage device such as a non-volatile memory. The storage unit stores the control program executed by the CPU. By executing the control program by the CPU, the control unit 50 implements various functions, including those within the sound source 501. Note that the functions within the sound source 501 may also be implemented by a DSP. FIG. 5 is a block diagram showing a configuration of the sound source 501. The sound source 501 includes a signal input unit 503, a sound data generation unit 511, a sound data storage unit 513, and a sound data output unit 507.

The signal input unit 503 is a terminal to which an external device is connected via a cable or the like. In the present embodiment, the signal input unit 503 is electrically connected to the first sensor 113 and the second sensors 115 provided in the frame 110, and the first sensor signal S1 and the second sensor signals S2 output from the first sensor 113 and the second sensors 115 are input, respectively. The signal input unit 503 outputs the input first sensor signal S1 and second sensor signals S2 to the sound source 501.

The first sensor signal S1 and the second sensor signals S2 are supplied to the sound data generation unit 511. The sound data generation unit 511 generates first sound data based on the first sensor signal S1, and generates second sound data based on the second sensor signals S2. The sound data generation unit 511 will be described later.

The sound data storage unit 513 includes a first sound data storage unit 513a and a second sound data storage unit 513b. The first sound data storage unit 513a and the second sound data storage unit 513b store different sound data that have been registered in advance. The sound data is sound waveform data. In the present embodiment, first sound data SD1 stored in the first sound data storage unit 513a is sound data obtained by sampling a sound when hitting the center of the drumhead of an acoustic drum, and second sound data SD2 stored in the second sound data storage unit 513b is sound data obtained by sampling a sound when hitting the outer edge of the drumhead of the acoustic drum.

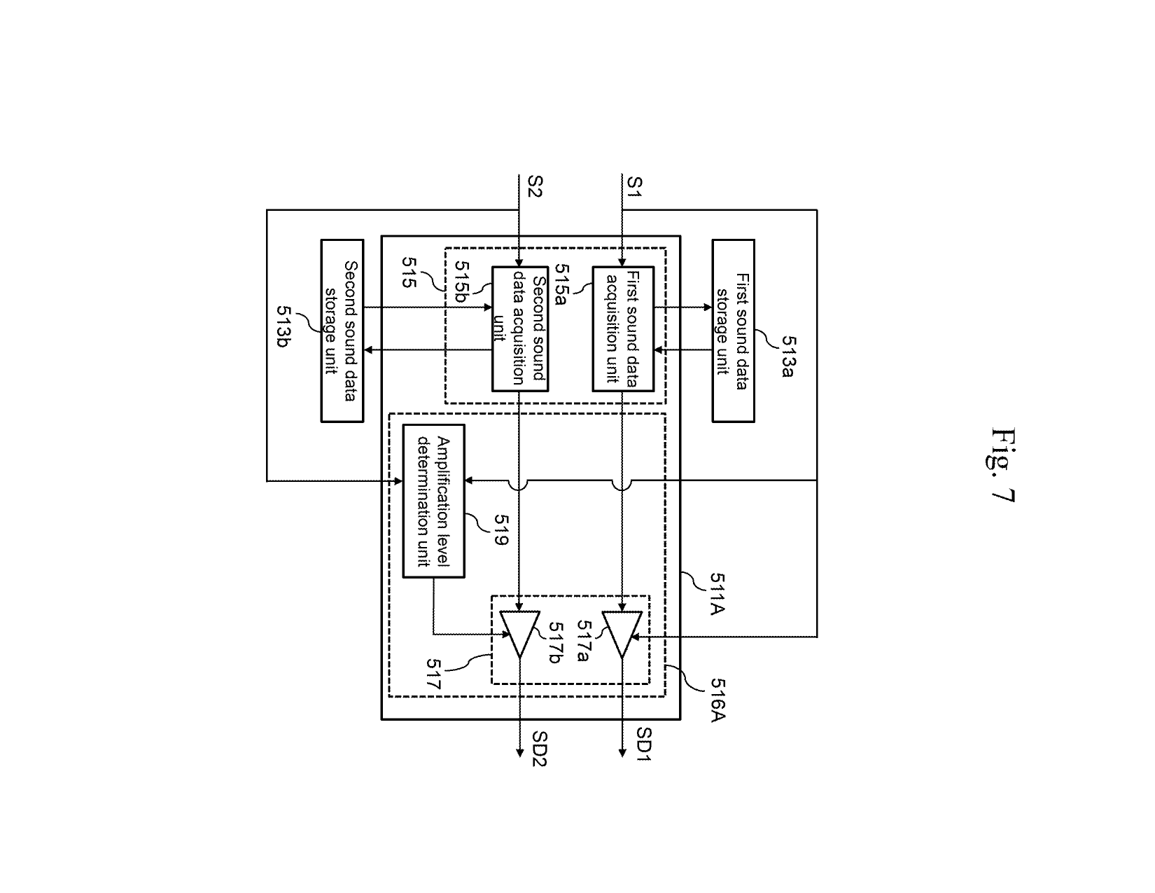

FIG. 6 is a block diagram showing a configuration of the sound data generation unit 511. The sound data generation unit 511 includes a sound data acquisition unit 515 and a data processing unit 516. The sound data acquisition unit 515 includes a first sound data acquisition unit 515a and a second sound data acquisition unit 515b.

The first sound data acquisition unit 515a acquires the first sound data SD1 from the first sound data storage unit 513, based on the first sensor signal S1. In addition, the second sound data acquisition unit 515b acquires the second sound data SD2 from the second sound data storage unit 513b based on the second sensor signals S2. In this case, the first sound data acquisition unit 515a acquires the first sound data SD1 from the first sound data storage unit 513a when the output intensity of the first sensor signal S1 becomes equal to or higher than a predetermined threshold. Similarly, the second sound data acquisition unit 515b acquires the second sound data SD2 from the second sound data storage unit 513b when the output intensity of the second sensor signals S2 becomes equal to or higher than a predetermined threshold. The first sound data acquisition unit 515a transmits the first sound data SD1 to the data processing unit 516. The second sound data acquisition unit 515b transmits the second sound data SD2 to the data processing unit 516.

The data processing unit 516 includes an amplifier unit 517 and an acoustic control unit 518. The amplifier unit 517 includes a first amplifier unit 517a and a second amplifier unit 517b. The first amplifier unit 517a acquires the first sound data SD1 from the first sound data acquisition unit 515a. In addition, the first amplifier unit 517a acquires the first sensor signal S1. The first amplifier unit 517a amplifies the first sound data SD1 based on the output intensity of the first sensor signal S1. The second amplifier unit 517b acquires the second sound data SD2 from the second sound data acquisition unit 515b. In addition, the second amplifier unit 517b acquires the second sensor signals S2. The second amplifier unit 517b amplifies the second sound data SD2 based on the output intensity of the second sensor signals S2.

In this case, the output intensity of the first sensor signal S1 is, for example, the maximum value of the output intensity of the first sensor signal S1 (the peak value of the amplitude of the first sensor signal S1), and the output intensity of the second sensor signal S2 is, for example, the maximum value of the output intensity of the second sensor signals S2 (the peak value of the amplitude of the second sensor signals S2). The first amplifier unit 517a transmits the amplified first sound data SD1 to the sound data output unit 507. The second amplifier unit 517b transmits the amplified second sound data SD2 to the acoustic control unit 518.

The acoustic control unit 518 acquires the first sensor signal S1 and the second sensor signals S2. In addition, the acoustic control unit 518 acquires the second sound data SD2 from the second amplifier unit 517b. The acoustic control unit 518 controls a residual sound of the sound corresponding to the second sound data SD2 according to the ratio between the output intensity of the first sensor signal S1 and the output intensity of the second sensor signals S2. For example, the acoustic control unit 518 controls the envelope (sustain) of the second sound data SD2 according to the ratio between the output intensity of the first sensor signal S1 and the output intensity of the second sensor signals S2. In this case, the output intensity of the first sensor signal S1 is, for example, the maximum value of the output intensity of the first sensor signal S1 (the peak value of the amplitude of the first sensor signal S1), and the output intensity of the second sensor signals S2 is, for example, the maximum value of the output intensity of the second sensor signals S2 (the peak value of the amplitude of the second sensor signals S2). For example, when the output intensity of the first sensor signal S1 is greater than the output intensity of the second sensor signals S2, the envelope of the second sound data SD2 is controlled so that the sustain time of the second sound data SD2 is shortened. As a result, it is possible to control the residual sound of the sound corresponding to the second sound data SD2. The acoustic control unit 518 transmits the second sound data SD2 to which a sound effect has been imparted to the sound data output unit 507.

The sound data output unit 507 acquires the first sound data SD1 and the second sound data SD2 transmitted from the sound data generation unit 511 simultaneously. The sound data output unit 507 mixes and outputs the acquired first sound data SD1 and second sound data SD2. The sound data output unit 507 outputs sound data SD3 obtained by mixing the first sound data and the second sound data to an external device, for example, a headphone, a speaker, or the like. A user of the electronic drum set 1 listens to a sound generated in response to the playing on the electronic drum set 1 via a sound-emitting device such as a headphone or a speaker.

As described above, in the present embodiment, the vibration imparted to the same sensing target (the drumhead 101) according to the playing is detected at different areas by the two types of sensors (the first sensor 113 and the second sensor 115). Different sound data (the first sound data SD1, the second sound data SD2) are assigned to the first sensor signal S1 output from the first sensor 113 and the second sensor signals S2 output from the second sensors 115, respectively. By processing these sound data based on the output intensity of the first sensor signal S1 and the output intensity of the second sensor signals S2, it is possible to realize a more natural and continuous sound change depending on the hitting position on the drumhead 101. In addition, since it is possible to omit the detection of the hitting position on the drumhead 101, changes in sound due to the playing can be realized with a small delay.

### Second Embodiment

In the first embodiment, in the sound data generation unit 511 of the sound source 501, the first sound data SD1 and the second sound data SD2 output from the sound data acquisition unit 515 are amplified by the amplifier unit 517 based on the output intensity of the first sensor signal S1 and the output intensity of the second sensor signals S2, respectively. Hereinafter, an example will be described in which the second sound data SD2 is amplified based on the ratio between the output intensity of the first sensor signal S1 and the output intensity of the second sensor signals S2.

FIG. 7 is a block diagram showing a configuration of a sound data generation unit 511A according to the present embodiment. In the present embodiment, since a configuration of the snare drum 10 is similar to that of the first embodiment, a description thereof will be omitted. In addition, since a configuration of the control device 50 is similar to that of the control device 50 described in the first embodiment except for the sound data generation unit 511A in the sound source 501, a redundant explanation will be omitted.

Referring to FIG. 7, the sound data generation unit 511A includes the sound data acquisition unit 515 and a data processing unit 516A. The sound data acquisition unit 515 includes the first sound data acquisition unit 515a and the second sound data acquisition unit 515b. Configurations of the first sound data acquisition unit 515a and the second sound data acquisition unit 515b are similar to those of the first embodiment. The first sound data acquisition unit 515a transmits the first sound data SD1 to the data processing unit 516A. The second sound data acquisition unit 515 transmits the second sound data SD2 to the data processing unit 516A.

The data processing unit 516A includes the amplifier unit 517 and an amplification level determination unit 519. The amplifier unit 517 includes the first amplifier unit 517a and the second amplifier unit 517b. The first amplifier unit 517a acquires the first sound data SD1 from the first sound data acquisition unit 515a. In addition, the first amplifier unit 517a acquires the first sensor signal S1. Similar to the first embodiment, the first amplifier unit 517a amplifies the first sound data SD1 based on the output intensity of the first sensor signal S1.

The second amplifier unit 517b acquires the second sound data SD2 from the second sound data acquisition unit 515b. Unlike the first embodiment, the second amplifier unit 517b amplifies the second audio data SD2 based on an amplification factor supplied from the amplification level determination unit 519.

The amplification level determination unit 519 acquires the first sensor signal S1 and the second sensor signals S2. The amplification level determination unit 519 determines the amplification factor of the second sound data SD2 based on the ratio between the output intensity of the first sensor signal S1 and the output intensity of the second sensor signals S2. The output intensity of the first sensor signal S1 is, for example, the maximum value of the output intensity of the first sensor signal S1, and the output intensity of the second sensor signals S2 is, for example, the maximum value of the output intensity of the second sensor signals S2.

Specifically, the amplification level determination unit 519 increases the amplification factor of the second sound data SD2 in the second amplifier unit 517b as the output intensity of the second sensor signals S2 increases relative to the output intensity of the first sensor signal S1. The amplification level determination unit 519 supplies the determined amplification factor to the second amplifier unit 517b.

As described above, the second amplifier unit 517b amplifies the second sound data SD2 based on the amplification factor supplied from the amplification level determination unit 519. The volume of the sound corresponding to the second sound data SD2 can be controlled based on the performer's playing. As a result, it is possible to realize a more natural and continuous sound change depending on the hitting position on the drumhead 101.

### Modifications

Modifications of the present disclosure will be described below.

### Modification 1

In the above embodiments, the first sensor 113 is arranged at the center of the frame 110, and the second sensors 115 are arranged at the outer edge 116 side at an equal distance from the center of the frame 110. However, the position of the first sensor 113 is not limited to the center of the frame 110. For example, the first sensor 113 is arranged in an area (fourth area) surrounded by different areas (first area, second area, and third area) in which at least three second sensors 115 are arranged.

### Modification 2

In the first embodiment, the acoustic control unit 518 controls the envelope of the second sound data SD2 to control the residual sound of the sound corresponding to the second sound data SD2. However, the control of the residual sound of the sound corresponding to the second sound data SD2 may be omitted.

### Modification 3

In the above embodiments, an example in which the frame 110 is applied to the snare drum 10 has been described. However, the first sensor 113 and the second sensor 115 may be applied to the bass drum, the tom drum, the floor tom drum, the hi-hat cymbals 20, the crash cymbal, and the ride cymbal.

In addition, the first sensor 113 and the second sensor 115 may be applied to an electronic musical instrument other than the electronic drum set 1. For example, the first sensor 113 and the second sensor 115 can be applied to a mallet-type electronic musical instrument such as an electronic marimba, an electronic string musical instrument such as a guitar synthesizer, an electronic wind musical instrument, and the like. For example, if the electronic musical instrument is the electronic marimba, the sensing target is a sound board, if the electronic musical instrument is the guitar synthesizer, the sensing target is a string, and if the electronic musical instrument is the electronic wind musical instrument, the sensing target is air flowing into a blowing section.

In the case where the first sensor 113 and the second sensor 115 are applied to an electronic musical instrument other than the electronic drum set 1, there may be one more second sensors 115. For example, if the electronic musical instrument is the electronic marimba, the first sensor 113 may be arranged at one end of the sound board, and the second sensor 115 may be arranged at the other end of the sound board.

### Modification 4

In the above embodiments, the first sensor 113 and the second sensor 115 may be different types of sensors. In addition, a change in the same sensing target may be detected by different types of sensors with different physical quantities. For example, if the electronic musical instrument is the electronic wind musical instrument, the pressure and the flow rate of air blown into the blowing section by the user may be detected by arranging different types of sensors in the blowing section.

### Modification 5

In the above embodiments, the first sound data SD1 and the second sound data SD2 are mixed in the sound data output unit 507 in advance, and output to an external sound-emitting device such as a headphone or a speaker. However, the first sound data SD1 and the second sound data SD2 may not be mixed before being output to the sound-emitting device. In this case, a first sound-emitting device (for example, a first speaker) for outputting a sound based on the first sound data SD1 and a second sound-emitting device (for example, a second speaker) for outputting a sound based on the second sound data SD2 may be provided, the first sound data SD1 may be output to the first sound-emitting device, the second sound data SD2 may be output to the second sound-emitting device, and the two sound-emitting devices simultaneously emit sounds to output sounds in a mixed state.

### Modification 6

In the second embodiment described above, similar to the first embodiment, the acoustic control unit 518 may control the envelope of the second sound data SD2 output from the second amplifier unit 517b.

### Modification 7

In the above embodiments, the first sound data SD1 and the second sound data SD2, transmitted from the sound generation unit 511 or 511A simultaneously, are mixed in the sound data output unit 507 and output. However, the first sound data SD1 and the second sound data SD2 may be mixed in the data processing unit 516 or 516A of the sound generation unit 511 or 511A and transmitted to the sound data output unit 507.

What is claimed is:

1. An electronic musical instrument comprising:
a first sensor that detects a vibration of a sensing target that varies with playing, and outputs a first sensor signal corresponding to a detected vibration;
a second sensor that detects the vibration of the sensing target, and outputs a second sensor signal corresponding to the detected vibration, the second sensor being positioned differently from the first sensor; and
a sound source that generates first sound data based on the first sensor signal and second sound data based on the second sensor signal in response to the playing, and transmits the first sound data and the second sound data simultaneously.

2. The electronic musical instrument according to claim 1, wherein a difference between a first detection sensitivity of the first sensor with respect to a vibration in a first area in the sensing target and a second detection sensitivity of the first sensor with respect to a vibration in a second area in the sensing target is greater than a difference between a third detection sensitivity of the second sensor with respect to the vibration in the first area and a fourth detection sensitivity of the second sensor with respect to the vibration in the second area.

3. The electronic musical instrument according to claim 1, wherein:
the electronic musical instrument is a percussion instrument including a striking surface, and
the sensing target is the striking surface.

4. The electronic musical instrument according to claim 2, wherein:
the electronic musical instrument is a percussion instrument including a striking surface,
the sensing target is the striking surface, and
the first area is a center of the striking surface and the second area is an outer edge of the striking surface.

5. The electronic musical instrument according to claim 1, wherein the sound source mixes the first sound data and second sound data and outputs them as single data.

6. The electronic musical instrument according to claim 2, wherein the sound source mixes the first sound data and second sound data and outputs them as single data.

7. The electronic musical instrument according to claim 1, wherein the sound source controls residual sound of sound corresponding to the second sound data based on a ratio between an output intensity of the first sensor signal and an output intensity of the second sensor signal.

8. The electronic musical instrument according to claim 2, wherein the sound source controls residual sound of sound corresponding to the second sound data based on a ratio between an output intensity of the first sensor signal and an output intensity of the second sensor signal.

9. The electronic musical instrument according to claim 1, wherein the sound source outputs the first sound data to a first speaker and outputs the second sound data to a second speaker different from the first speaker.

10. The electronic musical instrument according to claim 2, wherein the sound source outputs the first sound data to a first speaker and outputs the second sound data to a second speaker different from the first speaker.
